(19) United States
(12) Patent Application Publication
(10) Pub. No.: US 2010/0261374 A1
(43) Pub. Date: Oct. 14, 2010

(54) Wall-mounted high definition multimedia interface conversion device

(76) Inventor: Tsung-Chin Hung, Taipei City (TW)

Correspondence Address: BACON & THOMAS, PLLC, 625 SLATERS LANE, FOURTH FLOOR, ALEXANDRIA, VA, 22314-1176, US

(21) Appl. No.: 12/591,808

(22) Filed: Dec. 2, 2009

(30) Foreign Application Priority Data
Apr. 8, 2009 (TW) 098205639

(51) Int. Cl. H01R 13/60; H01R 3/00

(52) U.S. Cl. 439/488; 439/535

(57) ABSTRACT

A wall-mounted HDMI conversion device has a plate, a circuit board, and a plate fixture receiving the circuit board therein and having a slotted hole and an opening. The plate is mounted to a hole on a wall and has a jack on a front side. The circuit board has an HDMI connector and a network socket set mounted on both sides thereof. The HDMI connector penetrates through the slotted hole and is exposed beyond the jack on the plate and the network socket set is exposed beyond the opening of the plate fixture. A conversion circuit is mounted on the circuit board to convert between HDMI signals and network signals. The present invention is mounted on a wall, transmits signals through network cables received inside the wall, thereby having network cable organized conveniently.

### BACKGROUND OF THE INVENTION

1. Field of the Invention

The present invention is related to a high definition multimedia interface (HDMI) conversion device, and more particularly to a wall-mounted HDMI conversion device.

2. Description of the Related Art

Owing to higher cost of HDMI cables and shorter transmission thereof, one kind of HDMI signal conversion box is available now to interchange HDMI signals and network signals, enabling the use of more cost-effective network cables for long-distance transmission of HDMI signals. If network cables are not planned and received well, they may be widely disbursed. The network cables are easily stepped, pulled or dragged, and this may result in loss of contact of the network cables and network socket and resulting in unstable signal transmission.

Computer networks have penetrated into almost every corner of modern life. Modern people increasingly rely on the access to such networks. In many new buildings, network cables are buried into walls in advance and are connected with pre-mount wall plates having network ports, so network cables are embedded into wall and become hidden cables. Likewise, if there is an HDMI conversion device, which is mounted on the wall and connected with network cables buried into the wall beforehand, the problem of disorganized network cables can be resolved.

### SUMMARY OF THE INVENTION

An objective of the present invention is to provide a wall-mounted HDMI conversion device converting between HDMI signals and network signals and having network cables organized inside the wall.

To achieve the foregoing objective, the wall-mounted HDMI conversion device has a plate and a circuit board.

The plate has a front side, a rear side, a wall-mounting fixture and a jack. The wall-mounting fixture is formed on the front side and adapted to be mounted on a wall. The jack is formed through the front side.

The circuit board is mounted on the rear side of the plate through a plate fixture, and has a conversion circuit, an HDMI connector, and a network socket set. The conversion circuit is mounted thereon for converting between an HDMI signal and a network signal. The HDMI connector is mounted on one side of the circuit board, is electronically connected with the conversion circuit, and corresponds to and exposed beyond the jack on the plate. The network socket set is mounted on the other side of the circuit board and is electronically connected with the conversion circuit.

The present invention can convert between HDMI signals and network signals and transmit the network signals through network cables inside a wall, thereby having the network cables received in the form of hidden lines and organized conveniently.

### BRIEF DESCRIPTION OF THE DRAWINGS

FIG. 1 is a perspective view of a wall-mounted HDMI conversion device of the present invention;

FIG. 2 is another perspective view of the wall-mounted HDMI conversion device of the present invention;

FIG. 3 is an exploded view in FIG. 1; and

FIG. 4 is a schematic view illustrating the connection of two wall-mounted HDMI conversion devices of the present invention.

### DETAILED DESCRIPTION OF THE INVENTION

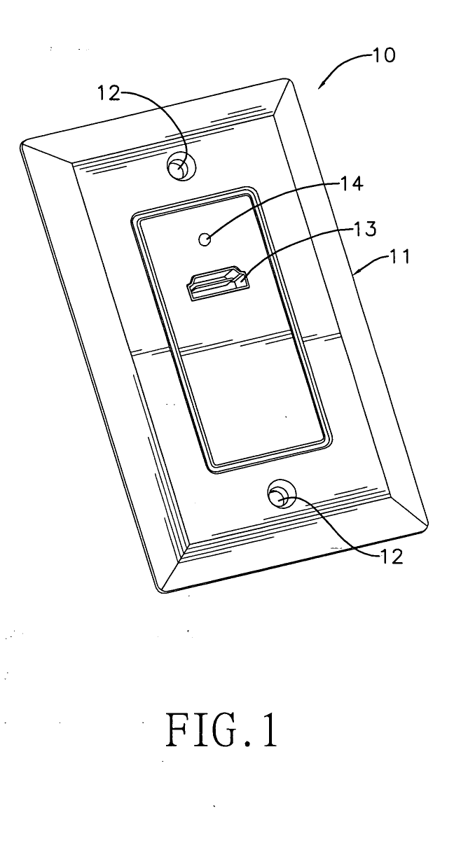

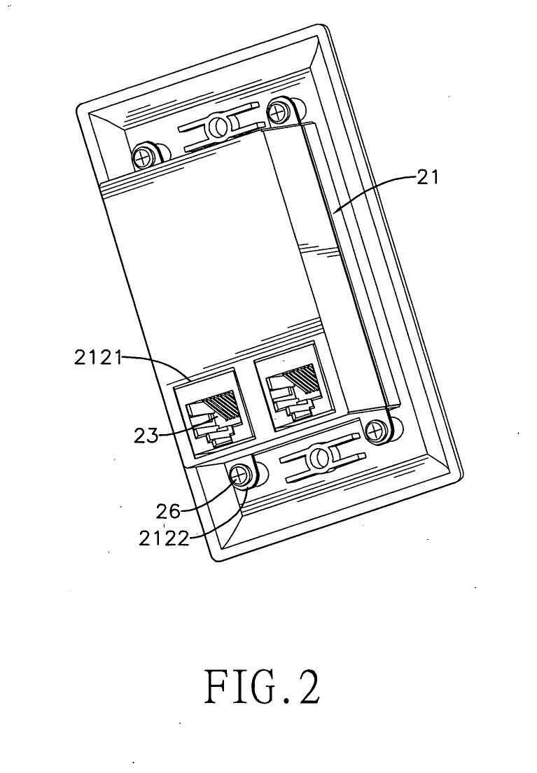

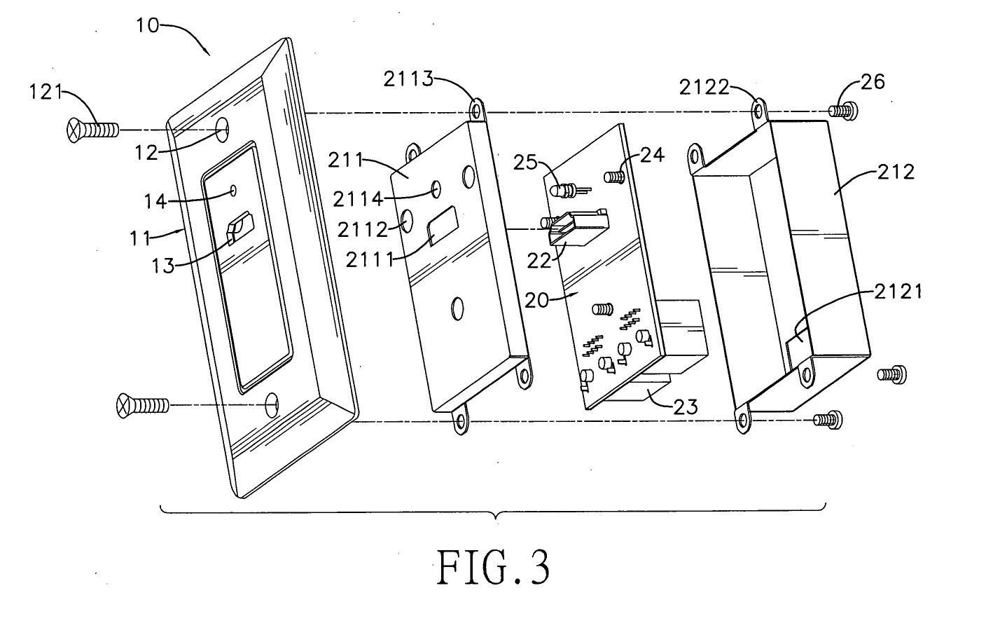

With reference to FIGS. 1 to 3, a wall-mounted HDMI conversion device (10) of the present invention has a plate (11), a circuit board (20) and a plate fixture (21).

The plate (11) has a front side, a rear side, a wall-mounting fixture (12) and a jack (13).

In the embodiment, the wall-mounting fixture (12) pertains to a pair of screw holes and a pair of screws (121). The screw holes are formed on two ends of the plate (11) for the plate (11) to be screwed on a wall by the screws (121) respectively. A jack (13) in compliance with the HDMI port specification is formed on the plate (11).

The circuit board (20) has a conversion circuit (not shown), an HDMI connector (22), and a network socket set (23). The conversion circuit is mounted on the circuit board (20) for converting between HDMI signals and network signals. The HDMI connector (22) and the network socket set (23) are mounted on two opposite sides of the circuit board (20) and are electronically connected with the conversion circuit. The HDMI connector (22) corresponds to the jack (13) on the plate (11) and is exposed beyond the jack (13).

The plate fixture (21) is an electric box. The circuit board (20) is received in the electric box. The electric box has a front cover (211) and a rear cover (212). The front cover (211) is connected with the rear side of the plate (11). A slotted hole (2111) is formed through the front cover (211) to correspond to the HDMI connector (22) for the HDMI connector (22) to stick out from the slotted hole. An opening (2121) is formed through the rear cover (212) for the network socket set (23) to be exposed beyond the opening (2121).

A plurality of screws (24) are mounted on the circuit board (20), and a through hole (2112) is formed through the front cover (211) to correspond to the each of the screws (24) for the screws (24) to penetrate through the front cover (211). The screws (24) respectively penetrate through the through holes (2112) to fasten the circuit board (20) on the rear side of the plate (11).

Moreover, four first lugs (2113) are respectively mounted on four corners of the front cover (211), and each first lug (2113) has a hole thereon. Four second lugs (2122) are respectively mounted on four corners of the rear cover (212), and each second lug (2113) has a hole thereon. Four screws (26) respectively penetrate through the first lugs (2113) and second lugs (2112) to fasten the front cover (211) and the rear cover (212) on the rear side of the plate (11).

The circuit board (20) further has an indicator (25). A first indicator hole (14) and a second indicator hole (2114) are respectively formed through the plate (11) and front cover (211) to correspond to the indicator (25). Hence, the indicator (25) can penetrate through the second indicator hole (2114) to emit light through the first indicator hole (14). The indicator (25) serves to display a connection status between an HDMI signal source and a wall-mounted HDMI conversion device. When the connection is normal, the HDMI signal source supplies power to the indicator (25), and the indicator is on. When the connection is abnormal, the HDMI signal source fails to supply power to the indicator (25), and the indicator (25) is off.

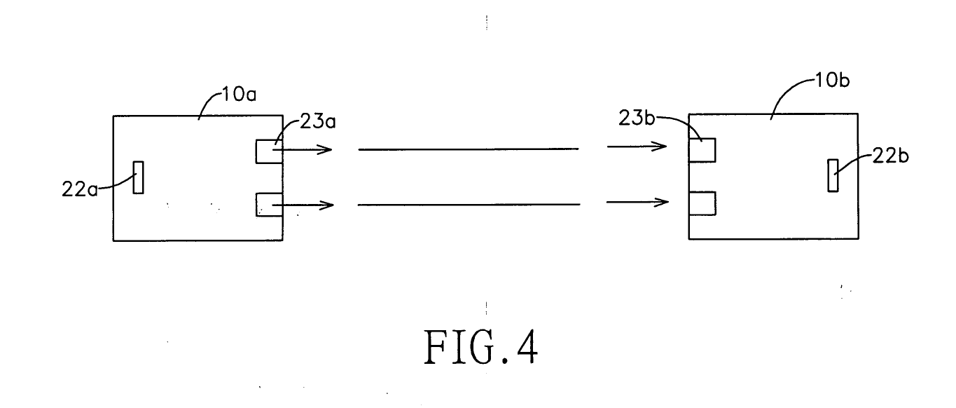

With reference to FIG. 4, the wall-mounted HDMI conversion device (10) is usually adopted in pairs during operation. One wall-mounted HDMI conversion device serves as an input converter (10a), and the other wall-mounted HDMI conversion device serves as an output converter (10b). The conversion circuit on the input converter (10a) converts HDMI signals into network signals. The conversion circuit of the output converter (10b) converts received network signals into HDMI signals. When the HDMI connector (22a) of the input converter (10a) is electronically connected with an HDMI signal source through an HDMI cable, the inputted HDMI signals are converted into network signals by the conversion circuit of the circuit board (20a) of the input converter (10a). The network signals are further transmitted out through the network socket set (23a) and a network cable. The network signals are received by the network socket set (23b) of the output converter (10b) from the network cable, and are converted into HDMI signals by the conversion circuit on the circuit board (20b) of the output converter (10b). The HDMI signals are further outputted to an HDMI connector (22b) electronically connected to a display device through an HDMI cable electronically connected to the HDMI connector (22b).

In sum, the present invention is mounted on a wall and serves for long-distance transmission through network cables connected therewith and pre-buried inside walls. As such, network cables are not disorderly scattered all around but well organized conveniently.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A wall-mounted HDMI conversion device, comprising:
a plate having
a front side;
a rear side;
a wall-mounting fixture formed on the front side and adapted to be mounted on a wall; and
a jack formed through the front side; and
a circuit board mounted on the rear side of the plate through a plate fixture, and having
a conversion circuit mounted thereon for converting between an HDMI signal and a network signal;
an HDMI connector mounted on one side of the circuit board, electronically connected with the conversion circuit, and corresponding to and exposed beyond the jack on the plate; and
a network socket set mounted on the other side of the circuit board and electronically connected with the conversion circuit.

2. The wall-mounted HDMI conversion device as claimed in claim 1, wherein the conversion circuit converts the HDMI signal into the network signal, and the network signal is transmitted out through the network socket set.

3. The wall-mounted HDMI conversion device as claimed in claim 1, wherein the conversion circuit converts the network signal into the HDMI signal, and the HDMI signal is transmitted out through the HDMI connector.

4. The wall-mounted HDMI conversion device as claimed in claim 1, wherein the plate fixture is an electric box and comprises:
a front cover having
a slotted hole corresponding to the HDMI connector for the HDMI connector to stick out therefrom;
a plurality of through holes formed thereon; and
four first lugs respectively formed on four corners thereof, each having a hole thereon;
a rear cover having
an opening corresponding to the network socket set for the network socket set to stick out therefrom;
four second lugs respectively formed on four corners thereof, each having a hole thereon; and
a plurality of first screws respectively passing through the holes of the front cover and the rear cover to be screwed into the plate; and
the circuit board is received in the electric box and further comprises:
a plurality of second screws and each passing through the corresponding through hole on the front cover to be screwed into the plate.

5. The wall-mounted HDMI conversion device as claimed in claim 2, wherein the plate fixture is an electric box and comprises:
a front cover having
a slotted hole corresponding to the HDMI connector for the HDMI connector to stick out therefrom;
a plurality of through holes formed thereon; and
four first lugs respectively formed on four corners thereof, each having a hole thereon;
a rear cover having
an opening corresponding to the network socket set for the network socket set to stick out therefrom;
four second lugs respectively formed on four corners thereof, each having a hole thereon; and
a plurality of first screws respectively passing through the holes of the front cover and the rear cover to be screwed into the plate; and
the circuit board is received in the electric box and further comprises:
a plurality of second screws and each passing through the corresponding through hole on the front cover to be screwed into the plate.

6. The wall-mounted HDMI conversion device as claimed in claim 3, wherein the plate fixture is an electric box and comprises:
a front cover having
a slotted hole corresponding to the HDMI connector for the HDMI connector to stick out therefrom;
a plurality of through holes formed thereon; and
four first lugs respectively formed on four corners thereof, each having a hole thereon;
a rear cover having
an opening corresponding to the network socket set for the network socket set to stick out therefrom;
four second lugs respectively formed on four corners thereof, each having a hole thereon; and
a plurality of first screws respectively passing through the holes of the front cover and the rear cover to be screwed into the plate; and
the circuit board is received in the electric box and further comprises:
a plurality of second screws and each passing through the corresponding through hole on the front cover to be screwed into the plate.

7. The wall-mounted HDMI conversion device as claimed in claim 4, wherein the circuit board further comprises an indicator corresponding to a first indicator hole formed through the plate and to a second indicator hole formed through the front cover of the electric box so that the indicator penetrates through the second indicator hole to emit light through the first indicator hole.

8. The wall-mounted HDMI conversion device as claimed in claim 5, wherein the circuit board further comprises an indicator corresponding to a first indicator hole formed through the plate and to a second indicator hole formed through the front cover of the electric box so that the indicator penetrates through the second indicator hole to emit light through the first indicator hole.

9. The wall-mounted HDMI conversion device as claimed in claim 6, wherein the circuit board further comprises an indicator corresponding to a first indicator hole formed through the plate and to a second indicator hole formed through the front cover of the electric box so that the indicator penetrates through the second indicator hole to emit light through the first indicator hole.

10. The wall-mounted HDMI conversion device as claimed in claim 7, wherein the wall-mounting fixture comprises a pair of screw holes and a pair of third screws.

11. The wall-mounted HDMI conversion device as claimed in claim 8, wherein the wall-mounting fixture comprises a pair of screw holes and a pair of third screws.

12. The wall-mounted HDMI conversion device as claimed in claim 9, wherein the wall-mounting fixture comprises a pair of screw holes and a pair of third screws.
